(19) United States
(12) Patent Application Publication
(10) Pub. No.: US 2023/0038274 A1
(43) Pub. Date: Feb. 9, 2023

(54) WATER VESSEL TRANSPORT RACK DEVICE

(71) Applicant: Marty Brand, Clinton, SC (US)

(72) Inventor: Marty Brand, Clinton, SC (US)

(21) Appl. No.: 17/548,710

(22) Filed: Dec. 13, 2021

Related U.S. Application Data
(60) Provisional application No. 63/228,747, filed on Aug. 3, 2021.

(51) Int. Cl. B60P 3/10; B62D 33/02; B63B 32/83; B60R 9/08

(52) U.S. Cl. CPC B60P 3/10; B60R 9/08; B62D 33/0207; B63B 32/83

(57) ABSTRACT

The present invention relates to a water vessel transport rack device primarily comprised of a frame that is further comprised of a front primary frame end, a rear primary frame end, a front secondary frame end and a rear secondary frame end. The front primary frame end and the rear primary frame end are identical in structure. Further, the front secondary frame end and the rear secondary frame end are identical in structure. The primary and secondary frame ends connect to one another, such that they form a plurality of surfaces that can be used to store a plurality of water vessels. Further, the device can be easily placed and secured within the bed of a pickup truck to allow a user to transport multiple water vessels while only using a single pickup.

### CROSS-REFERENCE TO RELATED APPLICATION

The present application claims priority to, and the benefit of, U.S. Provisional Application No. 63/228,747, which was filed on Aug. 3, 2021 and is incorporated herein by reference in its entirety.

### FIELD OF THE INVENTION

The present invention relates generally to the field of water vessel transportation devices. More specifically, the present invention relates to a water vessel transport rack device primarily comprised of a frame that is further comprised of a front primary frame end, a rear primary frame end, a front secondary frame end and a rear secondary frame end. The front primary frame end and the rear primary frame end are identical in structure. Further, the front secondary frame end and the rear secondary frame end are identical in structure. The primary and secondary frame ends connect to one another such that they form a plurality of surfaces that can be used to store a plurality of water vessels. Further, the device can be easily placed and secured within the bed of a pickup truck to allow a user to transport multiple water vessels while only using a single pickup. In addition, the frame is comprised of a plurality of eyelets that allow the water vessels to be secured to the frame via tie-down straps or other fasteners of the like. Accordingly, the present disclosure makes specific reference thereto. Nonetheless, it is to be appreciated that aspects of the present invention are also equally applicable to other like applications, devices and methods of manufacture.

### BACKGROUND

Many individuals partake in and enjoy recreational water activities such as kayaking, canoeing, paddle boarding, surfing, etc. However, said water vessels are extremely large, and require a pickup truck or trailer to transport to a body of water. In addition, multiple individuals may wish to carpool to a body of water in order to enjoying kayaking, canoeing, paddle boarding, etc. However, due to the space restraints of a pickup bed, only a certain number of water vessels can be stored within the bed. Multiple water vessels can be stored on a trailer, however it is not always desirable to transport a trailer as trailers may decrease fuel efficiency and create another potential hazard a driver has to worry about while driving. In addition, when transporting any number of water vessels an individual typically ties the vessels to the bed of a pickup. However, vessels can be tied ineffectively, such that the ties come loose during transport. As a result, the vessel or vessels can fall into a roadway, which not only damages the vessel, but also may cause a fatal accident.

Therefore, there exists a long-felt need in the art for an improved means of transporting water vessels. There also exists a long-felt need in the art for a water vessel transport rack device that allows a user to easily transport a plurality of water vessels within a single pickup truck bed. Further, there exists a long-felt need in the art for a water vessel transport rack device that adequately secures a water vessel within a bed of a pickup truck. Finally, there exists a long-felt need in the art for a water vessel transport rack device that eliminates the need to utilize a trailer to transport multiple water vessels.

The subject matter disclosed and claimed herein, in one embodiment thereof, comprises a water vessel transport rack device. The device is primarily comprised of a frame that is further comprised of a front primary frame end, a rear primary frame end, a front secondary frame end and a rear secondary frame end. The front primary frame end and the rear primary frame end are identical in structure. Further, the front secondary frame end and the rear secondary frame end are identical in structure. The primary and secondary frame ends connect to one another, such that they form a plurality of surfaces that can be used to store a plurality of water vessels. Further, the device can be easily placed and secured within the bed of a pickup truck to allow a user to transport multiple water vessels while only using a single pickup. In addition, the frame is comprised of a plurality of eyelets that allow the water vessels to be secured to the frame via tie-down straps or other fasteners of the like.

In this manner, the water vessel transport rack device of the present invention accomplishes all of the forgoing objectives and provides an improved means of transporting water vessels. Further, the device allows a user to easily transport a plurality of water vessels within a single pickup truck bed and ensures that the vessels remain secure within the bed during transport. Finally, the device eliminates the need to utilize a trailer to transport multiple water vessels. Accordingly, the water vessel transport rack device overcomes the limitations of existing methods of transporting water vessels known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a water vessel transport rack device. The device is primarily comprised of a frame that is further comprised of a front primary frame end, a rear primary frame end, a front secondary frame end and a rear secondary frame end. All components of the frame are preferably manufactured from a durable metal or rigid plastic. The front primary frame end and the rear primary frame end are identical in structure. In addition, the front secondary frame end and the rear secondary frame end are identical in structure. The device can used to be store and/or transport a plurality of water vessels such as, but not limited to, kayaks, canoes, paddle boards, surf boards or any other water vessels of the like. The architecture of the frame further allows for water vessels to be stored in a plurality of positions/orientations on the frame.

The front and rear primary frame ends are comprised of at least one horizontal cross member and at least two (but preferably three) vertical members. The members may be integrally-formed and/or attached via welding or molding, or may be removably-attached via at least one coupler in differing embodiments. The at least two vertical members further contact a ground surface and act as legs to allow the frame to stand on its own. The front/rear secondary frame ends sit atop the horizontal cross members and may be integrally formed and/or attached via welding or molding, or may be removably-attached via at least one coupler to the horizontal cross members of the front/rear primary frame ends. The secondary ends are further comprised of at least one horizontal cross member and at least two vertical members that may be integrally-formed and/or attached via welding or molding, or may be removably-attached via at least one coupler to one another to form each secondary end. The horizontal cross members of the primary front/rear frame ends may further be comprised of at least two front angled frame members positioned at an angle of 90-degrees or less in relation to the horizontal members.

To allow the front primary frame end to attach to the rear primary frame end, the frame is comprised of at least two primary horizontal frame members that attach to the at least two vertical members of each end. In differing embodiments, the horizontal frame members may be integrally-formed and/or attached via welding or molding, or may be removably-attached via at least one coupler to the at least two vertical members of each end. Further, the front secondary frame end attaches to the rear secondary frame end in the same manner.

The device can be removably-placed within the bed of a pickup truck to allow a user to transport a plurality of water vessels using the pickup. The device may be fixedly-attached (e.g. bolted) or removably-attached to the bed, such that it can be removed once a user arrives at a location (ex. a body of water) and used on the ground surface close to a body of water to store the water vessels. Any component of the frame may further be comprised of at least one eyelet that has a continuous opening that allows a user to attach a tie-down strap, rope or other fastener to the frame to secure the water vessels to the frame. As a result, a user can utilize any cargo-securing strap or device of the like, to secure the vessels such that they cannot fall off the frame during transport.

Accordingly, the water vessel transport rack device of the present invention is particularly advantageous as it provides an improved means of transporting water vessels. The device further allows a user to easily transport a plurality of water vessels within a single pickup truck bed while the vessels remain secure within the bed. Finally, the device eliminates the need to utilize a trailer to transport multiple water vessels. In this manner, the water vessel transport rack device overcomes the limitations of existing methods of transporting water vessels known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a water vessel transport rack device of the present invention while empty in accordance with the disclosed architecture;

FIG. 2 illustrates a side perspective view of one potential embodiment of a water vessel transport rack device of the present invention while empty in accordance with the disclosed architecture;

FIG. 3 illustrates a front perspective view of one potential embodiment of a water vessel transport rack device of the present invention while storing a plurality of water vessels in accordance with the disclosed architecture; and

FIG. 4 illustrates a front perspective view of one potential embodiment of a water vessel transport rack device of the present invention while storing a plurality of water vessels while the device is in the bed of a pickup truck in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved means of transporting water vessels. There also exists a long-felt need in the art for a water vessel transport rack device that allows a user to easily transport a plurality of water vessels within a single pickup truck bed. Further, there exists a long-felt need in the art for a water vessel transport rack device that adequately secures a water vessel within a bed of a pickup truck. Finally, there exists a long-felt need in the art for a water vessel transport rack device that eliminates the need to utilize a trailer to transport multiple water vessels.

The present invention, in one exemplary embodiment, is comprised of a water vessel transport rack device primarily comprised of a frame that is further comprised of a front primary frame end, a rear primary frame end, a front secondary frame end and a rear secondary frame end. The front primary frame end and the rear primary frame end are identical in structure. Further, the front secondary frame end and the rear secondary frame end are identical in structure. The primary and secondary frame ends connect to one another such that they form a plurality of surfaces that can be used to store water vessels. Further, the device can be easily placed and secured within the bed of a pickup truck to allow a user to transport multiple water vessels while only using a single pickup. In addition, the frame is comprised of a plurality of eyelets that allow the water vessels to be secured to the frame via tie-down straps or other fasteners of the like.

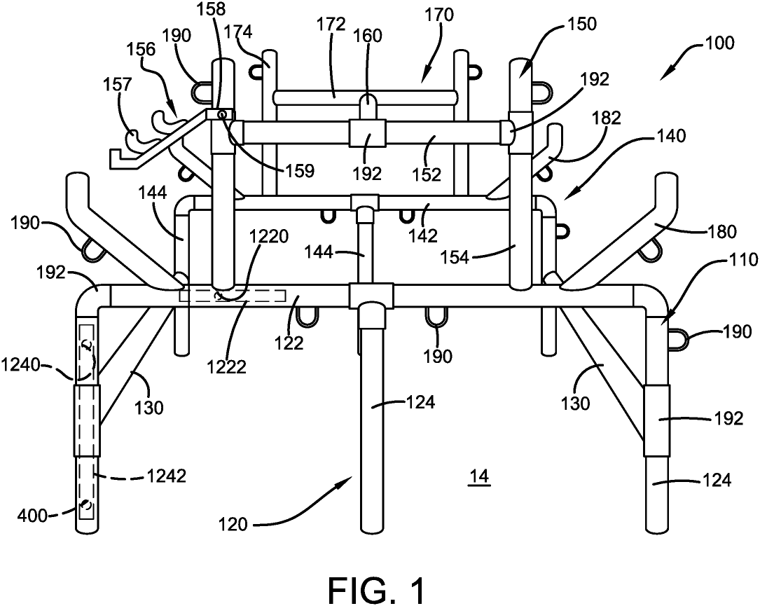

Referring initially to the drawings, FIG. 1 illustrates a front perspective view of one potential embodiment of a water vessel transport rack device 100 of the present invention while empty in accordance with the disclosed architecture. The device 100 is comprised of a frame 110 that is further comprised of a front primary frame end 120, a rear primary frame end 140, a front secondary frame end 150 and a rear secondary frame end 170. The frame 110 and all components are preferably manufactured from a durable, tubular or non-tubular metal such as, but not limited to, stainless steel or aluminum. In an additional embodiment, the frame 110 and all components may be manufactured from a rigid plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, PVC, recycled plastic, biodegradable plastic, etc.

The front primary frame end 120 is further comprised of at least one horizontal cross member 122 and at least two (but preferably three) vertical members 124. In differing embodiments, the members 122, 124 may be integrally formed and/or attached via welding or molding, or may be removably-attached via at least one coupler 192 (e.g. a PVC style coupler). The at least two vertical members 124 further contact a ground surface 14 and act as legs to allow the frame 110 to stand on its own. A front secondary frame end 150 sits atop the horizontal cross member 122 of the primary arm end 120. The secondary end 150 may be integrally-formed and/or attached via welding or molding, or may be removably-attached via at least one coupler 192 to the horizontal cross member 122. The secondary end 150 is further comprised of at least one horizontal cross member 152 and at least two vertical members 154 that may be integrally-formed and/or attached via welding or molding, or may be removably-attached via at least one coupler 192 to one another. The horizontal cross member 122 may further be comprised of at least two front angled frame members 180 positioned at an angle of 90-degrees or less in relation to the horizontal member 122.

The rear primary frame end 140 is further comprised of at least one horizontal cross member 142 and at least two (but preferably three) vertical members 144. In differing embodiments, the members 142, 144 may be integrally-formed and/or attached via welding or molding, or may be removably-attached via at least one coupler 192. The at least two vertical members 144 further contact a ground surface 14 and acts as legs to allow the frame 110 to stand on its own. A rear secondary frame end 170 sits atop the horizontal cross member 142 of the primary arm end 140. The secondary end 170 may be integrally-formed and/or attached via welding or molding, or may be removably-attached via at least one coupler 192 to the horizontal cross member 142. The secondary end 170 is further comprised of at least one horizontal cross member 172 and at least two vertical members 174 that may be integrally-formed and/or attached via welding or molding, or may be removably-attached via at least one coupler 192 to one another. The horizontal cross member 142 may further be comprised of at least two rear-angled frame members 182 positioned at an angle of 90-degrees or less in relation to the horizontal member 142.

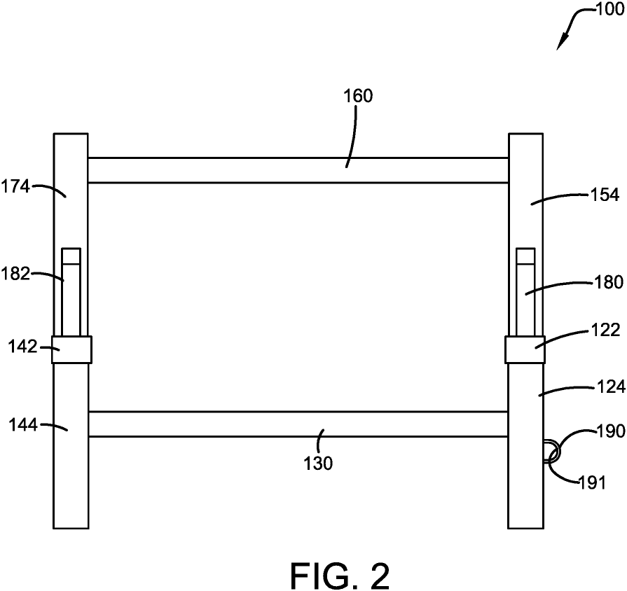

FIG. 2 illustrates a side perspective view of one potential embodiment of a water vessel transport rack device 100 of the present invention while empty in accordance with the disclosed architecture. To allow the front primary frame end 120 to attach to the rear primary frame end 140, the frame 110 is comprised of at least two primary horizontal frame members 130 that attach to the at least two vertical members 124, 144 of each end 120, 140. In differing embodiments, the horizontal frame members 130 may be integrally-formed and/or attached via welding or molding, or may be removably-attached via at least one coupler 192 to the at least two vertical members 124, 144 of each end 120, 140. Further, to allow the front secondary frame end 150 to attach to the rear secondary frame end 170, the frame 110 is comprised of at least one secondary horizontal frame member 160 that attaches to the at least one horizontal cross member 152, 172 of each end 150, 170. In differing embodiments, the horizontal frame member 160 may be integrally-formed and/or attached via welding or molding, or may be removably-attached via at least one coupler 192 to the at least one horizontal cross member 152, 172 of each end 150, 170.

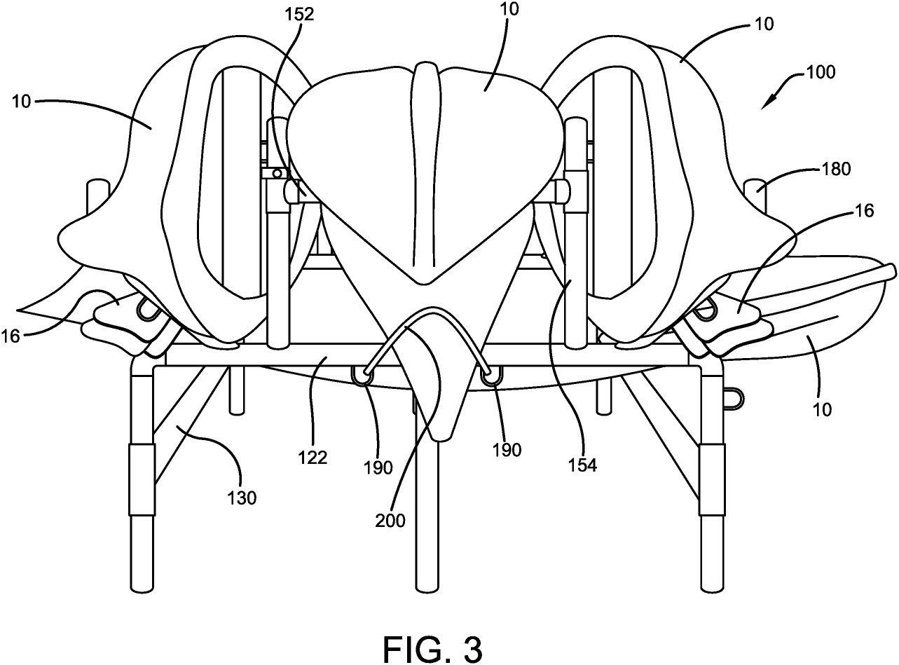

FIG. 3 illustrates a front perspective view of one potential embodiment of a water vessel transport rack device 100 of the present invention while storing a plurality of water vessels 10 (shown as prior art) in accordance with the disclosed architecture. The device 100 can used to be store and/or transport a plurality of water vessels 10 such as, but not limited to, kayaks, canoes, paddle boards, surf boards, or any other water vessel of the like. The architecture of the frame 110 allows for water vessels 10 to be stored in a plurality of positions/orientations. Said positions/orientations include, but are not limited to, on top of each horizontal cross member 122, 142, in between each vertical member 124, 144 and each angled frame member 180, 182, on top of each primary horizontal frame member 130 and/or on top of each horizontal cross member 152, 172. In the embodiment of the frame 110 shown in FIG. 3, the frame 110 allows for the storage of 5 water vessels 10. However, the frame 110 can be appropriately sized to allow a user to store any number of vessels 10.

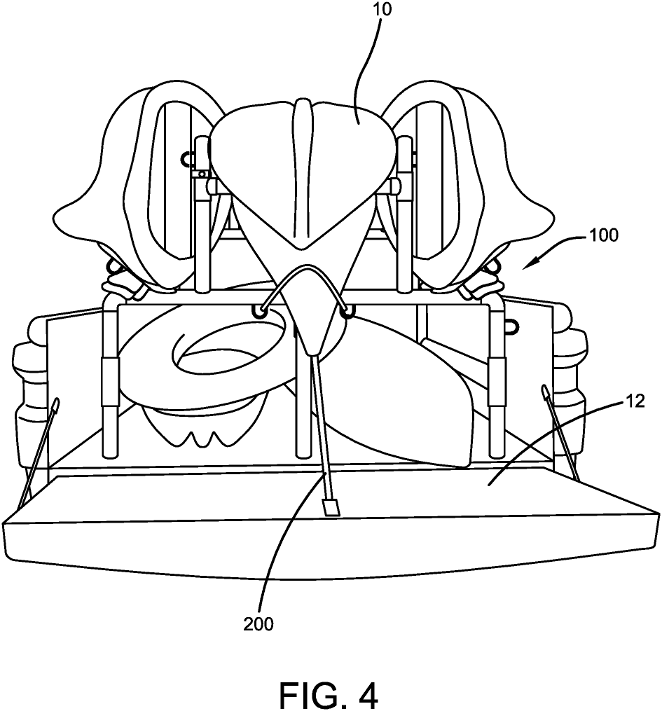

FIG. 4 illustrates a front perspective view of one potential embodiment of a water vessel transport rack device 100 of the present invention while storing a plurality of water vessels 10 (shown as prior art) while the device 100 is in the bed 12 of a pickup truck (shown as prior art) in accordance with the disclosed architecture. The device 100 can be removably-placed within the bed 12 of a pickup truck to allow a user to transport a plurality of water vessels 10 using only the pickup. The device 100 may be fixedly-attached (e.g. bolted) or removably-attached to the bed 12 such that it can be removed once a user arrives at a location (ex. a body of water) and used on the ground surface 14 close to a body of water to store the water vessels 10. In order to allow the water vessels 10 to be secured to the device 100 during transport, any component of the frame ends 120, 140, 150, 170 or horizontal frame members 130, 160 may be comprised of at least one eyelet 190 that is manufactured from the same material as the frame 110. The eyelet 190 further has a continuous opening 191 that allows a user to attach a tie-down strap 200, rope or other fastener to the frame 110 to secure the vessels 10 to the frame 110. In this manner, a user can utilize any cargo-securing strap or device of the like to secure the vessels 10, such that they cannot fall off the frame 110 during transport. In addition, the eyelets 190 can allow any cargo securing strap or device of the like to secure the frame 110 itself to the pickup bed 12 using any fastening structures (not shown) present within the bed 12 from the manufacturer or via aftermarket installation by the vehicle owner. In addition, the device 100 can also be used to store paddles 16 of any water vessel 10.

It should also be noted that in one embodiment, the device 100 is comprised of at least one horizontal internal member 1222 and at least one vertical internal member 1242. The horizontal internal member 1222 rests within at least one horizontal cross member 122, wherein the both the horizontal internal member 1222 and the horizontal cross member 122 have at least one corresponding continuous opening 1220 that allows a pin 300 of any pin type known in the art to be inserted through each opening 1220. In this manner, the cross member 122 can be pulled outwards such that more of the internal member 1222 becomes revealed, allowing the frame 110 to expand in width. Similarly, The vertical internal member 1242 rests within at least one horizontal cross member 124, wherein the both the vertical internal member 1242 and the horizontal cross member 124 have at least one continuous opening 1240 that allows a pin 300 of any pin type known in the art to be inserted through each opening 1240. In this manner, the cross member 124 can be pulled outwards such that more of the internal member 1242 becomes revealed, allowing the frame 110 to expand in height. As a result, the dimensions (e.g. width and height) of the frame 110 can be easily resized as necessary to fit differing sized truck beds 12 and/or locations. In a further embodiment, the internal members 1222, 1242 may have a spring-loaded capture pin 400 that secures the internal members 1222, 1242 at a specific position within each cross member 122, 124. Further, any other portion of the frame 110 may have similar height/width expanding capabilities as described.

One embodiment of the device 100 (as best seen in FIG. 1) may also have at least one (but preferably four) detachable bike arm(s) 156 that allows at least one bicycle (not shown) to be stored on the frame 110. The arm 156 further removably or fixedly attaches to any portion of the frame 110 (but preferably attaches to at least one vertical cross member 154) via a bracket 158 that can be secured on both sides of the frame 110 area wherein the arm 156 is attached. The bracket 158 is further preferably secured via at least one fastener 159 such as but not limited to: a bolt, a screw, a pin, etc. Further, the arm 156 is comprised of at least one hook 157 that allows a user to hang at least one bicycle from the arm 156.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “water vessel transport rack device” and “device” are interchangeable and refer to the water vessel transport rack device 100 of the present invention.

Notwithstanding the forgoing, the water vessel transport rack device 100 of the present invention and its various components can be of any suitable size and configuration as is known in the art without affecting the overall concept of the invention, provided that they accomplish the above-stated objectives. One of ordinary skill in the art will appreciate that the size, configuration and material of the water vessel transport rack device 100 as shown in the FIGS. are for illustrative purposes only, and that many other sizes and shapes of the water vessel transport rack device 100 are well within the scope of the present disclosure. Although the dimensions of the water vessel transport rack device 100 are important design parameters for user convenience, the water vessel transport rack device 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A water vessel transport rack device comprising:
a front primary frame end;
a rear primary frame end;
at least two primary horizontal frame members that connects the front primary frame end to the rear primary frame end;
a front secondary frame end;
a rear secondary frame end;
at least one secondary horizontal frame member that connects the front secondary frame end to the rear secondary frame end;
at least two angled frame members located on the front primary frame end;
at least two angled frame members located on the rear primary frame end; and
at least one eyelet.

2. The water vessel transport rack device of claim 1, wherein a plurality of water vessels are removably attached to the water vessel transport rack device.

3. The water vessel transport rack device of claim 2, wherein the plurality of water vessels are more than one of a kayak, a canoe, a paddle board and a surfboard.

4. The water vessel transport rack device of claim 2, wherein the water vessel transport rack device is placed in a bed of a pickup truck to allow a user to transport the plurality of water vessels.

5. The water vessel transport rack device of claim 2 further comprising a tie-down strap attached to the at least one eyelet for securing the plurality of water vessels to the water vessel transport rack device.

6. A water vessel transport rack device comprising:
a frame comprised of:
a front primary frame end;
a rear primary frame end;
at least two primary horizontal frame members that connects the front primary frame end to the rear primary frame end;
a front secondary frame end;
a rear secondary frame end;
at least one secondary horizontal frame member that connects the front secondary frame end to the rear secondary frame end;
at least two angled frame members located on the front primary frame end;
at least two angled frame members located on the rear primary frame end; and
at least one eyelet further comprised of a continuous opening.

7. The water vessel transport rack device of claim 6, wherein a plurality of water vessels can be stored on the frame while the frame is placed within a bed of a pickup truck.

8. The water vessel transport rack device of claim 7, wherein the water vessel transport rack device is removably attached to the bed.

9. A water vessel transport rack device that can be used to transport a plurality of water vessels, the water vessel transport rack device comprising:
a frame sized and configured to receive the plurality of water vessels and comprising:
a front primary frame end comprised of at least one horizontal cross member and at least two vertical members;
a rear primary frame end of at least one horizontal cross member and at least two vertical members;
at least two primary horizontal frame members that connects the front primary frame end to the rear primary frame end;
a front secondary frame end;
a rear secondary frame end;
at least one secondary horizontal frame member that connects the front secondary frame end to the rear secondary frame end;
at least two angled frame members located on the at least one horizontal cross member of the front primary frame end;
at least two angled frame members located on the at least one horizontal cross member of the rear primary frame end; and
at least one eyelet having a continuous opening.

10. The water vessel transport rack device of claim 9, wherein the plurality of water vessels are a kayak, a canoe, a paddle board and a surfboard.

11. The water vessel transport rack device of claim 9, wherein the at least two horizontal cross members of the front primary frame end and the rear primary frame end act as legs to allow the frame to stand freely.

12. The water vessel transport rack device of claim 9, wherein the at least one horizontal cross member and the at least two vertical members of the front primary frame end are fixedly attached via at least one coupler.

13. The water vessel transport rack device of claim 9, wherein the at least one horizontal cross member and the at least two vertical members of the rear primary frame end are fixedly attached via at least one coupler.

14. The water vessel transport rack device of claim 9, wherein the at least one horizontal cross member and the at least two vertical members of the front secondary frame end are attached via at least one coupler.

15. The water vessel transport rack device of claim 9, wherein the at least one horizontal cross member and the at least two vertical members of the rear secondary frame end are removably attached via at least one coupler.

16. The water vessel transport rack device of claim 9, wherein the at least two angled frame members of the front primary frame end and the rear primary frame end are positioned at an angle of 90-degrees or less in relation to the at least one horizontal cross member of the front primary frame end and the rear primary frame end.

17. The water vessel transport rack device of claim 9, wherein the plurality of water vessels are stored on a top of each of the at least one horizontal cross member of the front primary frame end and the rear primary frame end, in between each of the at least two vertical members of the of the front secondary frame end and the rear secondary frame end and each angled frame member.

18. The water vessel transport rack device of claim 9 comprising a plurality of eyelets, wherein at least one of the plurality of eyelets is located on each of the front primary frame end, the rear primary frame end, the at least one primary horizontal frame member, the front secondary frame end, the rear secondary frame end, the at least one secondary horizontal frame member, the at least two angled members of the front primary frame end, and the at least two angled members of the rear primary frame end.

19. The water vessel transport rack device of claim 9 further comprising at least one of a tie down strap, a rope, or another fastener attached to the at least one eyelet.

20. The water vessel transport rack device of claim 9, wherein the at least one horizontal cross member and the at least two vertical members of the front primary frame end are removably attached via at least one coupler.
